(19) United States
(12) Patent Application Publication
(10) Pub. No.: US 2024/0179150 A1
(43) Pub. Date: May 30, 2024

(54) MANAGEMENT OF ACCESS RIGHTS TO DIGITAL FILES WITH POSSIBLE DELEGATION OF THE RIGHTS

(71) Applicant: INATYSCO, MONTPELLIER (FR)

(72) Inventors: Bastien CONFAIS, CARQUEFOU (FR); Gustavo ROSTIROLLA, MONTPELLIER (FR); François MARQUES, MONTPELLIER (FR)

(21) Appl. No.: 18/283,658

(22) PCT Filed: Mar. 22, 2022
(86) PCT No.: PCT/FR2022/050520

§ 371 Date: Sep. 22, 2023

(30) Foreign Application Priority Data
Mar. 25, 2021 (FR) FR2103009

(51) Int. Cl. H04L 9/40

(52) U.S. Cl. CPC H04L 63/101; H04L 63/0435

(57) ABSTRACT

The present invention relates to a method for exchanging data between a delegator device (I2) and a delegate device (I3) for access to an encrypted dataset, an access entry specific to the delegator device and associated with said dataset being stored in a public access list of an access management base, a decryption key for said dataset being able to be computed by the delegator device using the access entry, the method comprising the following steps, implemented by a processing unit of the delegator device (I2): —receiving (1100) an identification value specific to the delegate device (ID(U3, f1)) and associated with said file, —generating (1200) a delegation value (Del) on the basis of said identification value, such that the delegate device is able to subsequently receive the delegation value, obtain the access entry specific to the delegator device using the delegation value and compute the decryption key for said dataset.

### FIELD OF THE INVENTION

This invention falls within the field of distributed computer systems for transmitting and sharing digital data.

The invention more specifically relates to a method for exchanging data between a so-called “delegator” computer device and a so-called “delegate” computer device, whose respective roles in the sharing of data will become apparent from the description given hereinafter, as well as to a method for exchanging data between a delegate device and an access management database. The invention also relates to a computer device comprising a processing unit used to implement the exchange of data, a system for sharing encrypted datasets comprising such a device, a computer program product for implementing the exchange of data and storage means readable by a computer for implementing the exchange of data.

### PRIOR ART

It is well-known in the prior art to control access to a computer file containing sensitive data, for example using cryptographic techniques. In particular symmetric or asymmetric encryptions are known, in which access to the file requires knowledge of a decryption key.

In a very simple solution for controlling access to a computer file for users present on a network (for example on the Internet), the computer file is encrypted and publicly accessible. Owing to the encryption, although the file is accessible without any controls, the access to the information contained in the file is controlled. The owner of the computer file generates a decryption key and must exchange directly over the network with each user authorized to access the file to transmit the key to the user. The publication Design of PriServ, a Privacy Service for DHTs, Jawad, Serrano-Alvarado, Valduriez (2008), Proceedings of the 2008 International Workshop on Privacy and Anonymity in the Information Society, PAIS '08, Association for Computing Machinery, pp.21-25 for example describes a solution for managing access rights based on exchanges of keys.

A first drawback of this approach is that an interception of the exchanges by a third-party attacker, or a theft of the identity of the authorized user by a third-party attacker, would both compromise the security of the file encryption. A second significant drawback is the need for the simultaneous connection of the file owner and the user that has to receive the access rights, with each new share.

To palliate these drawbacks, certain distributed databases, of the prior art take on the problem of access rights management using solutions of “blockchain” type, i.e. with a distributed registry in which the allocation of access rights depends on a consensus between the entities holding the rights, with no single central control authority. In such a solution, each link in the blockchain contains the necessary information to guarantee that the exchanged files are intact.

One example of this is the publication Blockchain-Based, Decentralized Access Control for IPFS, Steichen and al. (2018), 2018 IEEE International Conference on Internet of Things (iThings), pp. 1499-1596. In this publication, the users of the blockchain access an access control list, known as an ACL, shared between them via the blockchain, before authorizing any new user to access the file. Provision is made for directly sharing the file with the new authorized user, as long as the consensus is reached between the users of the blockchain. The file is not encrypted.

This solution allows an asynchronous distribution of the access rights, without the users being connected at the same time. However, one drawback is that the security of the access control relies entirely on the trust placed in the users of the blockchain, since access to the content does not require knowledge of a key.

The publication FileTribe: Blockchain-Based Secure File Sharing on IPFS, Sari, Sipos (2019), European Wireless 2019; 25^{th} European Wireless Conference, pp. 1-6, makes provision for keeping the advantages of a cryptographic encryption of files while using a consensus between the users of a blockchain.

In this solution, the shared files are encrypted using a symmetric decryption key. The symmetric decryption key is itself encrypted and can be decrypted by the users of the blockchain. To supply access rights to a new user, a new encryption of the symmetric decryption key is performed collectively. One advantage is that a third-party user obtaining the file without going via the blockchain cannot access the content; however, such a solution is very burdensome in terms of computation time and required storage space, since the key must be encrypted again at each share with a new authorized user. Given these difficulties, it is impractical to deploy the abovementioned solution on a large scale.

In addition, in the abovementioned solution, the access control list ACL is public and accessible in “plaintext” with no controls, so that any third-party user can know the identity of the users authorized to access the file simply by consulting the access control list ACL.

Another issue not satisfactorily resolved is the possible revocation of access rights; solutions that rely on a blockchain do not allow for the removal of access rights in a simple manner. In general, to prevent previously authorized users from continuing to access the contents of the file, it is necessary to generate a new file or a new file decryption key.

Other solutions for managing access to files have been proposed, such as an attribute-based decryption solution or else a “proxy re-encryption” solution, but these solutions are very complex at the computational level. The computing power and energy consumption of these access rights management solutions make them impractical for large-scale deployment.

From the above it is apparent that the distributed management of access rights using a blockchain via the solutions known to the prior art has advantages, but is not very easy to use in practice.

Another drawback of all the abovementioned solutions is that they do not allow, for a user previously authorized to access the file, for said user to temporarily delegate his access rights to another entity present on the network without the latter entity being itself able to delegate the access rights.

Such a distribution of rights would for example be relevant when users connected to a telecommunications network and authorized to access a given file wish to use a computation server with very high computing power, this computation server being shared on said network. It would then be advisable to allow the computation server to temporarily access the file, while ensuring that this access does not allow the computation server to supply permanent access rights to other entities.

### GENERAL DESCRIPTION OF THE INVENTION

With regard to the previous text, one aim of the invention is to supply a solution for sharing encrypted datasets between several remote computer devices in which it is easy to supply temporary access rights to a new computer device for a given protected dataset—for example to a computation server used intermittently. The desired solution must for example allow the targeted sharing of symmetric or asymmetric encryption keys associated with protected datasets.

Another important issue is that of limiting the storage space required on the respective memories of the computer devices involved in the method for sharing the encrypted datasets, particularly by comparison with solutions of the prior art of “blockchain” type which only make it possible to add registry entries and in which the storage space required increases over time. It is also desirable to limit the required computations to simplify and secure the sharing protocols.

It is also desirable to have a data-sharing solution that does not require all the computer devices holding access rights to be connected and available simultaneously to generate the new temporary access rights.

Finally, a secondary aim of the invention is to handle any revocation of access rights; the owner of the data is then able to revoke access rights previously granted for the data, by rendering these accesses obsolete.

To meet the abovementioned needs, a first aspect of the invention relates to a method for exchanging data between a delegator device and a delegate device for an access to an encrypted dataset stored in a memory,
an access entry specific to the delegator device and associated with said dataset being stored in a public access list of an access management database, a decryption key of said dataset being computable by the delegator device using the access entry,
the method comprising the following steps implemented by a processing unit of the delegator device:
   receiving an identification value specific to the delegate device and associated with said dataset,
   generating a delegation value as a function of the identification value specific to the delegate device,
such that the delegate device can subsequently receive the delegation value, obtain the access entry specific to the delegator device using the delegation value and compute the decryption key of said dataset.

Optionally and without limitation, the method for exchanging data according to this first aspect of the invention can moreover have the following technical features, take alone or in any of the possible combinations:
the identification value specific to the delegate device depends on a private key of the delegate, said identification value being constructed such that a third party cannot obtain said identification value of the delegate without knowing the private key of the delegate.
the identification value specific to the delegate device, denoted ID(U3, f1), is obtained as follows: ID(U3, f1)=U3+sha256(concatenation (U3, f1)) where f1 is said encrypted dataset, and where U3 is a private key of the delegate device.
the delegation value is computed by the processing unit as a function of said identification value specific to the delegate device, and as a function of an identification value specific to the delegator device and associated with said dataset.
the identification value specific to the delegator device depends on a private key of the delegator, said identification value specific to the delegator being constructed such that a third party cannot obtain said identification value specific to the delegator without knowing the private key of the delegator.
the delegation value is equal to a difference between the identification value specific to the delegator device associated with said dataset and the identification value specific to the delegate device associated with said dataset.
the delegation value is equal to a pair.
a first element of said pair depends on a difference between the identification value specific to the delegator device associated with said dataset and the identification value specific to the delegate device associated with said dataset.
a second element of said pair is equal to an anonymous identification value for the delegate specific to the delegator device and associated with said dataset.
the first element of said pair depends on a random number obtained by the delegate device.
it comprises the transmission to the delegate device of a signed message containing the delegation value, for example a message signed by DSA signature.
the decryption key of said dataset comprises a symmetric decryption key, for example a decryption key obtained by an AES algorithm or by a 3DES algorithm.
a value of the decryption key of said encrypted dataset depends on a function Aut verifying the following equality: Aut(ID(U2, f1), ACL(U2, f1), 0)=Aut(ID(U3, f1), ACL(U2, f1), Del) where f1 is said encrypted dataset, where U2 is a private key of said delegator device, where U3 is a private key of said delegate device, where Del is said delegation value, where ID(U2, f1) is said identification value specific to the delegator device, where ID(U3, f1) is said identification value specific to the delegate device, and where ACL(U2, f1) is said access entry specific to the delegator device.
the access entry specific to the delegator device and associated with said dataset has been previously obtained by an owner server as a function of the decryption key of said dataset, and has been stored in the access management database.
the obtaining of the access entry specific to the delegator device and associated with said dataset comprises sub-steps, implemented by the owner server, of:
   obtaining an identification value specific to the delegator device and associated with said dataset,
   receiving, from the access management database, an access entry specific to the owner server and associated with said dataset,
   computing the decryption key,
   computing the access entry specific to the delegator device associated with said
   dataset, as a function of said access entry specific to the owner server and as a function of said decryption key.
the public access list is distributed over a cloud infrastructure.
the public access list is implemented via a blockchain.
the public access list is distributed over a peer-to-peer network incorporating the delegator device and the delegate device.

According to a second aspect, the invention relates to a method for exchanging data between a delegate device and an access management database for an access to an encrypted dataset stored in a memory, an access entry specific to a delegator device and associated with said dataset being stored in the access management database, said access entry allowing the delegator device to obtain a decryption key of said dataset,
the delegate device having previously received a delegation value from the delegator device, after a data exchange process between the delegate and a delegator as defined above,
the method comprising the following steps implemented by a processing unit of the delegate device:
   obtaining the access entry specific to the delegator device and associated with said dataset,
   computing the decryption key of said dataset, as a function of the following three data: an identification value specific to the delegate device and associated with said dataset, the access entry specific to the delegator device previously obtained, and the delegation value previously received from the delegator device.

Optionally and without limitation, the method for exchanging data according to this second aspect of the invention can moreover have the following technical features, taken alone or in any of the possible combinations:
the obtaining of the access entry specific to the delegator device and associated with said dataset comprises:
   the transmission of a datum associated with the delegator device to the access management database,
   the receipt, from the access management database, of said access entry specific to the delegator device.
the datum transmitted to the access management database to obtain the access entry comprises an identifier of the delegator device.
the datum transmitted to the access management database to obtain the access entry comprises an anonymized identification value, specific to the delegator and associated with said dataset.
the method comprises subsequent steps, implemented by the processing unit of the delegate device, of:
   obtaining the encrypted dataset from a memory,
   and decrypting the encrypted dataset, using the previously computed key, preferably by symmetric decryption.

The invention further relates, according to a third aspect of the invention, to a delegator computer device comprising a processing unit configured to implement a method for exchanging data as defined above with a delegate device.

The invention also relates to a system for sharing encrypted datasets comprising such a computer device and further comprising:
an access server comprising an access management database in which is recorded a public access list including at least one access entry,
and at least one delegate device comprising a processing unit configured to implement a method for exchanging data as defined above between the delegate device and an access management database.

The system for sharing encrypted datasets may have, optionally and without limitation, the following technical features, taken alone or in any of the possible combinations:
the delegator device comprises a user server.
the delegate device comprises a computation server.
the system for sharing encrypted datasets further comprises a data-owning server configured to compute access entries specific to delegator devices associated with at least one encrypted dataset, and configured to share said access entries with the access server.

A fourth aspect of the invention relates to a computer program product comprising code instructions which, when said code instructions are executed by a processing unit, lead said processing unit to implement a method for exchanging data as defined above.

A fifth aspect of the invention relates to storage means readable by a computer on which are recorded code instructions which, when said code instructions are executed by a processing unit, lead said processing unit to implement a method for exchanging data as defined above.

### GENERAL DESCRIPTION OF THE FIGURES

Other features, aims and advantages of the invention will become apparent from the following description, which is given for illustration purposes and without limitation, and which must be read with reference to the appended figures among which:

FIG. 1 is a diagram representative of a data-sharing assembly according to an exemplary embodiment, in particular including a plurality of delegator devices, a plurality of delegate devices and an access management database.

FIG. 2 shows the steps of an example of a method for delegating access rights to an encrypted file, from a delegator device to a delegate device.

FIG. 3 shows the steps of an example of a method for accessing an encrypted file by a delegate device having previously received a delegation, preferably a temporary delegation.

FIG. 4 shows the steps of an example of a method for encrypting and recording a file by an owner device, allowing a possible subsequent delegation of access rights to the recorded encrypted file.

FIG. 5 shows the steps of an example of a method for generating access rights, preferably permanent, from an owner device to a delegating device.

FIG. 6 shows the steps of an example of a method for accessing an encrypted file by a delegator device for which access rights, preferably permanent, have been previously generated by an owner device.

### DETAILED DESCRIPTION OF PARTICULAR EMBODIMENTS OF THE INVENTION

In the entire description hereinafter, the different cryptographic values used for access management (decryption key, identification value, delegation value etc.) are specific to a single dataset. It will however be understood that said values used to manage access rights could also be common to several datasets determined by the respective owner or owners of said datasets. In particular, the decryption key of one dataset could also be valid for other determined datasets.

On all the appended figures and throughout the description hereinafter, similar items bear identical alphanumerical references.

In the remainder of the text, the example is used of encrypted datasets stored in a memory in the form of files. The invention is however not limited to this scenario but also extends to datasets stored in block mode (each set thus constitutes a data block, resulting, for example but not necessarily, from the division of a file into several blocks) or in object mode.

### *System for Sharing Encrypted Files

The description hereinafter relates to the management of access rights to encrypted files by entities of a network. It is considered that the entities have previously shared a rights management protocol with one another.

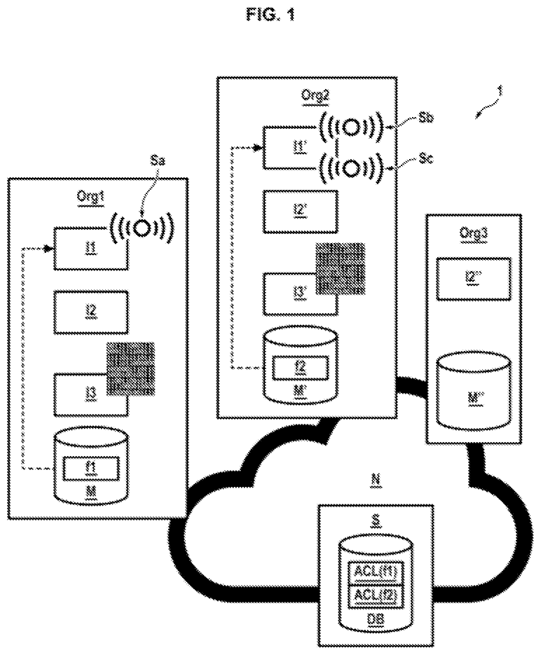

FIG. 1 schematically represents a system 1 for sharing files between computer devices of several organizations Org1, Org2, Org3, . . . , connected to one and the same network N, preferably a remote telecommunications network. The network N is typically an Internet, Intranet, telephone 3G, 4G, 5G, DECT, Bluetooth, etc. network.

In this example, the organizations Org1, Org2, Org3 are organizations for managing geophysical and/or environmental data. The term “geophysical data” should be understood to mean data relating to the physical features of the Earth, typically resulting from measurements. This can be geological and/or seismic and/or gravimetric and/or atmospheric and/or space data, etc. The term “environmental data” should be understood to mean data pertaining to the biological and human environment of an area, for example biological and/or sonic and/or chemical and/or hydrological and/or energetic and/or waste treatment-related data. These data are typically sensitive data made selectively available to organizations.

The organizations Org1, Org2, Org3 are for example remote from one another, and may belong to different local authorities.

Each of the organizations Org1, Org2, Org3 is for example a local authority and/or a private company involved in the collection or processing of data and/or a non-profit-making organization involved in the collection or processing of data and/or an organization which owns storage and/or computation servers.

It is here considered that each of the organizations Org1, Org2, Org3 is independent. The organizations for example wish to selectively pool a part of their hardware and of their data so that each of them can rely on at least a part of the resources and data of the other organizations.

Furthermore, here, the organization Org1 has a computation server I3 and the organization Org2 has a computation server I3′. The term “computation server” should be understood to mean a server having very high computational power, typically greater than each of the devices I1, I1′, I2, I2′, I2″, . . . . It is desirable to be able to selectively make one and/or the other of these servers I3 and I3′ available to the other organizations of the network in order to execute processing of geophysical and/or environmental data.

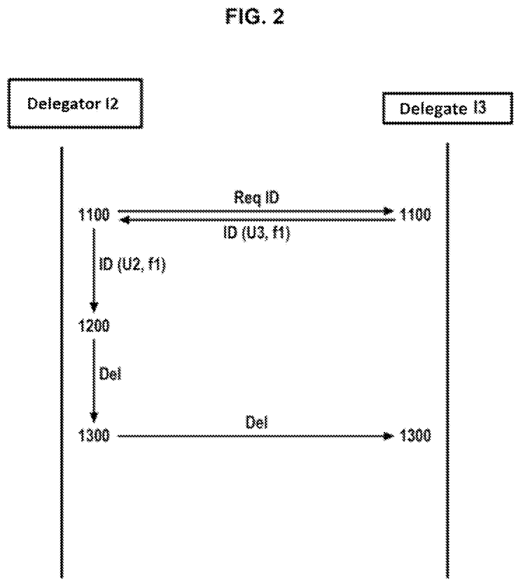

However, all of the description hereinafter, and particularly the descriptions of the different methods illustrated by FIGS. 2 to 6, are not limited to the case of geophysical and/or environmental data. These methods may advantageously be used whatever the type of content of the files or the type of the organizations Org1, Org2, Org3, . . . or also for two organizations. An application to geophysical and/or environmental data is advantageous, since the computational processing of said data may require high computational power. It is advisable for local authorities to be able to temporarily entrust certain processes to computation servers, without compromising the integrity and confidentiality of the data contained in the files.

Returning to FIG. 1, the system 1 comprises at least one access server S, storing an access management database DB. The access server S may be contained in a single computer device, or may be distributed over several devices (where applicable located remotely from one another and present on different sites), for example using hash tables and/or a blockchain.

The server S comprises a processing unit (not shown). In this example, the server S stores the different access lists ACL. A memory of the access management database DB (or, alternatively, a remote memory with which the database DB can communicate) comprises at least one access list ACL(f1) with at least one access entry for an encrypted file f1. In this example, the access management database DB also comprises an access list ACL(f2) with at least one access entry for an encrypted file f2. It will be understood that access entries to the files f1 and f2 may be allocated to different users.

Advantageously, all the nodes of the system 1 (i.e. here in particular the devices I1, I1′, I2, I2′, I2″, . . . ) can access each of the encrypted files f1, f2, . . . without controls, for example via a distributed storage system managing the memories M, M′, M″. The encrypted files f1, f2, . . . are then publicly available. The access to the information contained in the file is controlled by the presence of the encrypted keys, but the access to the file itself is preferably not controlled.

An access list, for example the list ACL(f1), typically comprises corresponding pairs. Each pair associates an identifier of a device (for example d(I2)) and a numerical value (for example ACL (U2, f1)) provided to allow said device to access the contents of the file f1.

For example, the access entry ACL (U2, f1) allows the device I2 to use its private key U2 to compute the value of a decryption key of the file f1.

The contents of the file f1 for example comprises collected data from the sensor Sa and/or from any of the other sensors.

The access list ACL is a public list. The term “public” should be understood to mean that the access list ACL is easily accessible by any of the devices of the organizations Org1, Org2, Org3, . . . as well as by devices belonging to third-party users. Preferably, no specific access control measure (relying for example on cryptographic keys and/or on a consensus by blockchain, etc.) is implemented to protect the contents of the access list ACL with regard to third-party users. The access list ACL is easy to view, at least in read-only mode, by each of the abovementioned users.

The private keys U1, U2, U1′, U2′, . . . , respectively belonging to the devices I1, I2, I1′, I2′, . . . , are themselves stored very securely. These are for example numerical values specific to each device. It is assumed that none of the devices shares its private key, either over the network N, or with any of the other devices.

Here, the system 1 further comprises:
for the organization Org1, an owner server I1 and a user server I2. The owner server I1 is configured to create encrypted files and to compute access entries specific to itself and/or to the user server I2 and/or to other devices present on the network N for these files; the organization Org1 further comprises, in this example, a sensor Sa provided to collect geophysical and/or environmental data. The sensor Sa can here exchange data with the server I1.
for the organization Org2, an owner server I1′ and a user server I2′. The owner server I1′ is configured to create encrypted files and to compute access entries specific to itself and/or to the user server I2′ and/or to other devices present on the network N for these files; the organization Org2 further comprises, in this example, two sensors Sb and Sc provided to collect geophysical and/or environmental data. The two sensors Sb and Sc can here exchange data with the server I1′.
for the organization Org3, a user server I2″. Here the organization Org3 does not have any significant computational power suitable for carrying out heavy processing on geophysical and/or environmental data.

The system 1 further comprises a storage memory M. The memory M can store the access lists ACL. Here, the memory M belongs to the organization Org1.

Alternatively, the memory M could be incorporated into the access server S and/or incorporated into any of the devices of one of the organizations Org1, Org2, Org3, . . . , or remote from each of these devices.

Moreover, the organization Org2 here has a storage memory M′, and the organization Org3 here has a storage memory M″.

Preferably, when several memories (here M, M′, M″) are present, a common namespace is used. The memories M, M′, M″ belong to a distributed storage system, for example embodied using an overlay network. Thus, when a user accesses an entry of the access list ACL, it is not necessary for the user to know in advance in what memory of the system 1 said entry of the access list is located.

Preferably, each device I1, I1′, I2, I2′, . . . polls the memory which is available in its local server; thus, in the example illustrated in FIG. 1, the device I1 can poll the memory M and the device I1′ can poll the memory M′. Insofar as the memories M, M′, and M″ belong to one and the same distributed storage system, the files stored in the other memories are also accessible.

Preferably, the recordings on a memory are not subsequently modifiable. This latter property is for example provided as a service by the distributed storage solution used.

Each encrypted file is recorded either on any of the memories M, M′, M″, . . . , or on a memory of the server S or on a remote memory. In this example, the file f1 is stored in the memory M of the organization Org1 and the file f2 is stored in the memory M′ of the organization Org2. Other files, preferably encrypted or where applicable unencrypted, may be recorded in the memory.

Each of the devices I1, I1′, I2, I2′, I2″, I3, I3′ comprises processing means such as for example a processing unit, not shown in FIG. 1.

Each of these processing units may comprise in the memory one or more computer program products comprising code instructions for implementing the methods described hereinafter, and/or can read one or more storage means readable by a computer on which are recorded code instructions for implementing the methods described hereinafter.

The organizations Org1, Org2, Org3 wish to be able to use the computation servers I3, I3′ in order to have access to their computational power to carry out processing on the geophysical and/or environmental data to which any of the devices I1, I1′, I2, I2′, I2″ has access according to the access lists ACL.

To do this, one wishes to assign an access (typically read-only) to one of the encrypted files f1 and/or f2 for one of the computation servers I3 and/or I3′, selectively and preferably temporarily.

Preferably, the data written by a given user in a file can no longer be modified, including preferably by the owner of said file. Such a prohibition on modifying the file data after their creation is for example provided, in the form of a service, by the distributed storage system used for the memories M, M′, M″.

The methods hereinafter make it possible to provide two levels of access to the files, as will be detailed hereinafter. The servers I2, I2′ and I2″ are considered as delegators; they may have access entries in their name in the access lists ACL. The servers I3 and I3′ re meanwhile delegates; they can receive a delegation coming from a delegator.

### *Delegation of temporary access rights to an encrypted file for a delegate (Example 1)

FIG. 2 shows successive steps of a method for exchanging data between a delegator device (for example I2 or I2′ or I2″) and a delegate device (for example I3 or I3′) according to an example. One aim of this method is to provide a delegation value Del to the delegate device I3, to allow said delegate I3 to access (preferably temporarily) an encrypted file f1 for which the delegator device I2 holds access rights. This method can be implemented by a processing unit of the delegator device I2, jointly with the delegate I3.

The encrypted file f1 is typically a read-only file. Alternatively, the contents of the file f1 can be modifiable in write mode once the access to the file f1 has been permitted.

Typically, the delegate device I3 is a computation server shared over the network N, used temporarily to lend its computational power.

For the delegator I2 to generate and transmit a delegation to the delegate I3, the delegator I2 should obtain an identification function value specific to the delegate I3 for the file f1. Specifically, the computation of the delegation Del subsequently assigned to the delegate I3 depends on said identification value.

Preferably, the identification function ID has been shared between the different organizations of the network before starting the data exchanges. For example, the identification function ID has been previously specified in the program code allowing the implementation of the different methods for exchanging data, and distributed with said program.

During the step 1100, the delegate I3 optionally receives an identification request Req ID from the delegator I2. The identification request Req ID preferably takes the form of a message addressed by the delegator I2 to the delegate I3. Then, the delegate I3 obtains or recomputes a value ID(U3, f1) which is specific to it for the identification function ID, based on an identity of the file f1 and based on its private key U3.

The identification value ID(U3, f1) depends on the private key U3 of the delegate I3. This identification value is constructed in such a way that a third party cannot obtain this value simply by knowing an identity of the file f1, without knowing the private key U3. The identification value ID(U3, f1) here also depends on the identity of the file f1; in other words, the identification values of the delegate I3 differ for each file.

Preferably, the results produced by the identification function ID seem random from the point of view of a third party which does not know the private key used, but these results are deterministic for the user who knows the private key used.

The identification function ID preferably has the following three properties:
The result ID(U3, f1) can only be computed by the delegate I3 holding its key U3;
Based solely on the knowledge of the result ID(U3, f1), it is extremely difficult for a third party to work back to the value of the private key U3;
The result ID(U3, f1) cannot be played back by a third party based on another encrypted file, for example based on the file f2 for which the third party might accidentally know the value ID(U3, f2).

Thus, the identification function ID allows users of the system 1 to exchange data for the purpose of assigning and/or using access rights to files, without any malicious third parties being able to guess the private keys of the users, or else illicitly access the contents of encrypted files.

The access rights management solution proposed here thus has a very high level of security, although the list ACL of the access management database DB is public and no access control is implemented at the level of this list ACL.

In this example (Example 1), the value ID(U3, f1) of the identification function ID is obtained as follows:

ID(U3,f1)=U3+sha256(concatenation(U3,f1)),

where f1 is said encrypted file and where U3 is the private key of the delegate I3. “Concatenation” corresponds to the concatenation function, and “sha256” corresponds to a known cryptographic hash function operating on a word size of 32 bits. It will be understood that it would be possible to use another hash function here.

In the step 1100, the delegate I3 transmits the value ID (U3, f1) to the delegator I2. Preferably, the value ID (U3, f1) is sent over a highly secure channel, for example using cryptographic functions. This ensures that the value ID(U3, f1) remains accessible solely to the delegator I2 and to the delegate I3, which are deemed to be trusted.

In a step 1200, using the identification value ID(U3, f1) specific to the delegate I3, the delegator I2 generates a delegation value Del for the delegate I3 and the file f1.

Preferably, the delegation value Del is computed by the delegator I2 as a function of the identification value ID(U3, f1) specific to the delegate device I3, and also as a function of an identification value ID(U2, f1) specific to the delegator I2 and associated with this file f1. Thus, since the identification value ID(U2, f1) remains secret, only a delegator device holding valid access rights to the file f1 can produce delegations.

In this example (Example 1), the delegation value Del is equal to the difference between the two identification values: Del=ID(U2, f1)−ID(U3, f1).

As will be described hereinafter, by constructing the decryption key sk, the delegate I3 will subsequently be able to decrypt the file based on the delegation value Del and based on an item of information about an access entry of the delegator I2.

Finally, in a step 1300, the delegator I2 transmits to the delegate I2 the delegation value Del.

It is preferable for the transmission of the delegation value Del to be done securely, since this delegation value gives an item of information concerning the identification values for the delegator I2 and the delegate I3.

Thus, the transmission 1300 to the delegate device I3 preferably takes the form of a signed message containing the delegation value Del. The message can be signed by any cryptographic signature algorithm, for example by DSA (Digital Signature Algorithm) signature.

The message signature makes it possible to check the non-repudiation property. Moreover, owing to the message signature, the delegate I3 can verify the integrity of the transmission of the delegation value, and check that the delegation does indeed come from the delegator I2. This is particularly important should the delegate I3 need the identity of the delegator I2 to decrypt the file.

A first advantage of the method of FIG. 2 is its simplicity and its speed of computation. A second advantage is that the delegator I2 and the delegate I3 do not need to be connected to the network simultaneously to other users (for example an owner 11 of the file f1) and do not need to upload files into the database DB during the method.

After the method of FIG. 2, the delegate I2 can access (preferably temporarily) the contents of the encrypted file f1, owing to its delegation. However, the delegate I2 does not have an entry in its own name in the access list ACL. Preferably, the delegate I2 cannot itself grant any delegation to other users for access to the file f1 of which it is not the owner. It is recalled that preferably, only the owner of the file f1 can add a recording of said file.

These latter properties can be embodied in particular by an access list ACL stored in the form of a blockchain, in which additions to the blockchain would be managed in the form of “smart contracts”.

It will be understood that the method of FIG. 2 can be repeated by the delegator I2 for as many iterations as there are different delegates requiring delegations for the file f1, and where applicable for other files available in the memory.

### *Access to an Encrypted File Using Temporary Access Rights (Example 1)

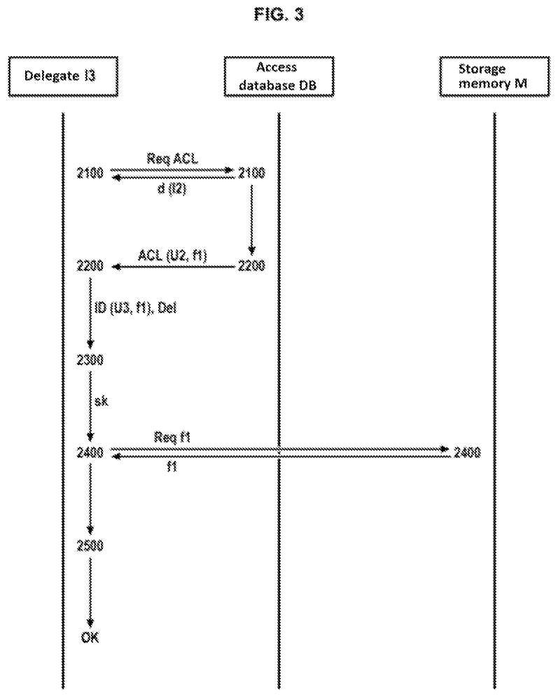

FIG. 3 illustrates steps of a method for exchanging data between a delegate device (for example I3 or I3′), an access management database DB containing a public access list ACL, and a file storage memory M, according to an example. The method can be implemented by a processing unit of the delegate device I3, jointly with the database DB. The delegate device uses a delegation value Del for the file f1 previously received from a delegator I2, allowing it to access the contents of the file f1 (preferably temporarily).

The delegation value Del comes, for example, from a method for exchanging data as described above, and as illustrated in FIG. 2.

To be able to access the contents of the encrypted file f1, the delegate I3 must obtain the value of the decryption key that locks the contents. Here this is the symmetric decryption key sk. To obtain said key, the delegate I3 uses the delegation value Del.

Firstly, the delegate I3 obtains from the database DB an item of information depending on an access entry ACL (U2, f1) specific to the delegator I2 for the file f1, by presenting an identifier d(I2) of the delegator I2 to the database DB. For example, the delegate I3 directly obtains the value of the access entry ACL (U2, f1). It is recalled that the access entries are public and that their viewing is not subject to access control.

Here, in a step 2100, the delegate I3 sends an identifier d(I2) of the delegator I2 to the access management database DB.

Then in a step 2200, the delegate I3 directly reads the value of the access entry ACL (U2, f1) in the public access list ACL of the database DB.

The delegate I3 is then in a position to compute the decryption key sk for the file f1, as a function of the following three data:
the identification value ID(U3, f1) specific to the delegate device I3 and associated with the file f1, that the delegate I3 may compute where applicable if it does not have it in the memory;
the access entry ACL(U2, f1) read in the access management database DB;
the delegation value Del previously generated by the delegator I3 and received by the delegate I3 (directly from the delegator or indirectly by way of a third-party device as a trusted third party), which may have been recorded in the memory beforehand.

It is recalled that the delegate I3 does not possess any access entry in its own name in the public list ACL, for the file f1.

The decryption key sk is preferably a symmetric decryption key. The encryption implemented for example corresponds for example to an AES (Advanced Encryption Standard) algorithm or else a 3DES (Triple Data Encryption Standard) algorithm but any algorithm can be used. The decryption key sk is here constructed as follows:

sk=Aut(ID(U3,f1),ACL(U2,f1),Del)[=Aut(ID(U2,f1),ACL(U2,f1),0)]
where f1 is the encrypted file,
where U2 is the private key of the delegator device I2,
where U3 is the private key of the delegate device I3,
where Del is the delegation value previously received by the delegate I3,
where ID(U2, f1) is the identification value specific to the delegator device I2,
where ID(U3, f1) is the identification value specific to the delegate device I3,
and where ACL(U2, f1) is the access entry specific to delegator device I2.

The authorization function Aut is chosen such as to verify the following equality:

Aut(ID(U3,f1),ACL(U2,f1),Del)=Aut(ID(U2,f1),ACL(U2,f1),0)

In a simple example, one uses as the result of the function Aut a sum of the three variables taken as input. Specifically, if the equality Del=ID(U2, f1)−ID(U3, f1) is verified as in the example above (Example 1), then the following equality is also verified:

ID(U3,f1)+ACL(U2,f1)+Del=ID(U2,f1)+ACL(U2,f1)

It is clear that the delegate I3 must of necessity know the delegation value Del to decrypt the file, failing which the knowledge of the value of the access entry ACL(U2, f1) is not useful to it. Provision is thus made for two different levels of access to the encrypted file f1; a first level of users do not need delegation (delegator I2) and a second lower level of users need a delegation, since they do not have an access entry in their own name (delegate I3).

Preferably, the authorization function Aut has been shared between the different organizations of the network before starting the data exchanges. It has for example been distributed to the different servers with the code of the program allowing the implementation of the method for exchanging data.

After step 2300, the delegate I3 holds the decryption key sk.

In a step 2400, which can be implemented immediately after the step 2300 or later on, the delegate I3 obtains the file f1 from a memory in which this file is stored. The file f1 is for example obtained from the memory M. For this purpose, the delegate I3 for example transmits a file request Req f1 to the memory M.

Finally, in a step 2500, the delegate I3 presents the value of the decryption key sk to access the file contents, preferably by symmetric decryption. The file f1 is of course not communicated in decrypted form via the network N.

If the delegate I3 is a computation server, it will be understood that the delegate I3 can implement the necessary computation sequences, then the result of the computation can be saved in the memory M in the network, optionally directly in the contents of the file f1. Alternatively, the computation result data are communicated to different organizations present on the network (typically to the delegator I2 and/or to the owner I1).

### *Recording of a New Encrypted File (Example 1)

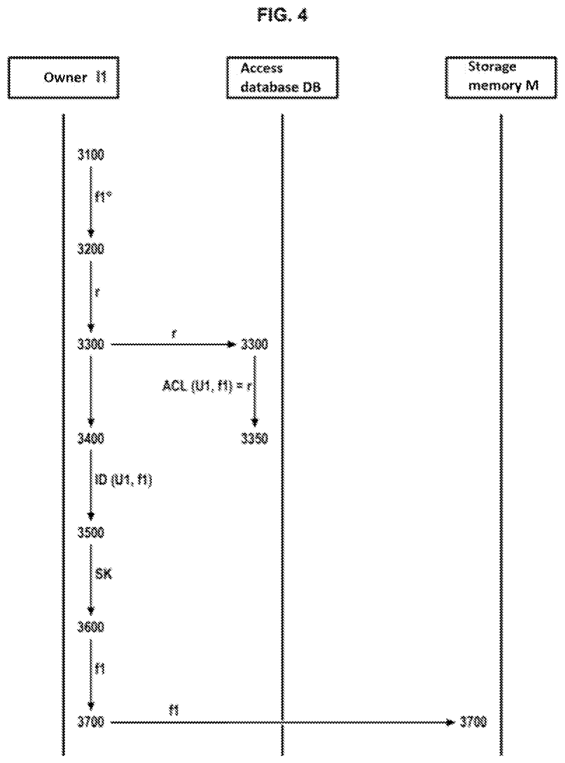

FIG. 4 illustrates successive steps of a method for creating a new protected file f1 intended to be shared via a sharing system such as the system 1, and for generating access rights for this file f1. The method is implemented by an owner device of the file f1 (for example an owner I1 or I1′), an access management database DB and a storage memory M.

In a step 3100, the owner I1 generates a new unencrypted file f₁⁰ or obtains its file from its internal memory. As indicated above, the data of the file f₁⁰ are for example sensitive scientific data that the owner I1 wishes to share with other users securely, while preserving the confidentiality of the data of the file f₁⁰.

In a step 3200, for the purpose of generating an access entry for the future encrypted file f1, the owner I1 draws a random number r, for example an integer.

The owner then transmits the random number r to the access management database DB, in a step 3300.

Next, in a step 3350, the access management database DB records an access entry for the owner I1 and for the future encrypted file f1, in the public list ACL. For example, the access entry ACL (U1, f1) is set equal to r. U1 is a private key of the owner I1.

The owner I1, meanwhile, computes in a step 3400 its identification value ID (U1, f1) for the file f1. In this example (Example 1), this identification value is computed as follows:

ID(U1,f1)=U1+sha256(concatenation(U1,f1)),

Based on its own identification value ID (U1, f1), combined with the value of the new access entry ACL (U1, f1), the owner I1 is able to obtain a decryption key sk value for the file f1. The value of the decryption key sk is constructed such that delegators I2, I2′, I2″ . . . can subsequently implement delegations as seen above, without involving the owner I1.

Thus, in a step 3500, the owner I1 computes a value of the decryption key sk using the authorization function Aut, for example according to the following formula:

sk=Aut(ID(U1,f1),ACL(U1,f1),0))

It is recalled that, in a simple example, a result of the authorization function Aut is a sum of the three variables taken as input by the authorization function.

In a step 3600, the contents of the file are encrypted using the key sk, in order to obtain the encrypted file f1.

Finally, in a step 3700, this file f1 is recorded on the storage memory M.

It will be understood that the step 3350 can be interchanged with the steps 3400, 3500, 3600 and 3700 or else implemented in parallel with these last steps.

Alternatively, the encrypted file f1 could be obtained by asymmetric encryption based on the unencrypted file f₁⁰. The encryption then relies on a private decryption key associated with a public decryption key. In the latter case, the authorization function Aut shared between the owner I1 and the different other users allows said users to reconstruct the private decryption key of the file f1.

### *Generation of Permanent Access Rights to an Encrypted File for a Delegator (Example 1)

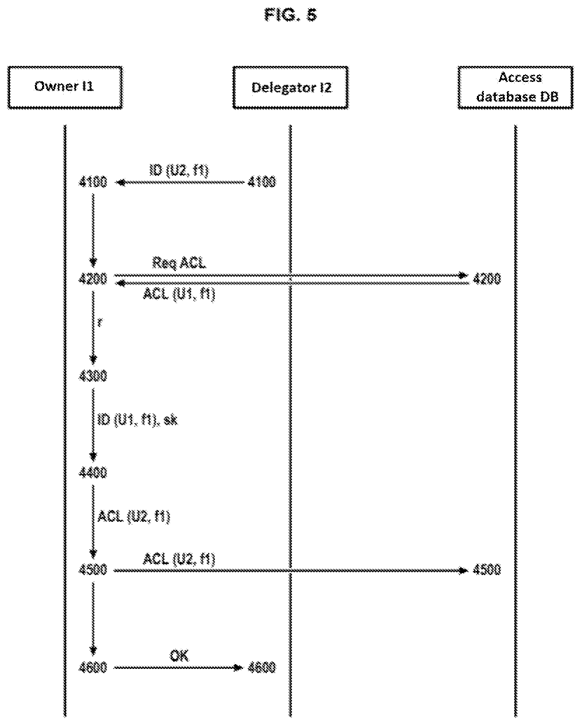

FIG. 5 illustrates steps of a method for exchanging data between an owner device (for example I1 or I1′), a delegator device (for example I2 or I2′ or I2″) and an access management database DB, according to an example. One aim of this method is to provide the delegator device I2 with access rights (preferably permanent) to a protected file f1. The method can be implemented by a processing unit of the owner I1, in association with the delegator I2 and the database DB.

The file f1 for example comes from a file-recording method as described above, illustrated in FIG. 4. Similarly, the access entry ACL (U1, f1) of the owner I1 is, preferably, obtained as described above in relation to FIG. 4.

During the method of FIG. 5, the owner I1 generates a new public access list ACL (U2, f1) associated with the delegator I2.

Thus, once the access list ACL (U2, f1) is generated and recorded in the database DB, the delegator I2 can subsequently access the contents of the file f1 without needing any delegation, and without needing the owner I1 to be connected.

In a step 4100, the delegator I2 transmits to the owner I1 its identification value ID (U2, f1) for the file f1. It is recalled that the identification function ID has, preferably, been shared by all the organizations of the network before starting the exchanges.

In this Example 1, the identification function ID has the same properties already mentioned above in relation to FIG. 2 and the transmission is done in the same way. In particular:
The identification function ID(U2, f1) preferably depends on the private key U2 of the delegator and is preferably constructed such that a third party cannot obtain said identification value without knowing the private key U2. Thus, any malicious third-party users cannot guess the private keys of the users, or else illicitly access the contents of the file f1, by intercepting the exchanges;
The value ID (U2, f1) is transmitted in the step 4100 over a highly secure channel, for example using cryptographic functions, to ensure that only the owner I1 and the delegator I2 know said value.

In a step 4200, the owner I1 obtains the value of its own access entry ACL (U1, f1) for the file f1, from the database DB. For example, the owner I1 transmits an access request Req ACL and in return retrieves the access entry ACL (U1, f1). This value ACL (U1, f1) can otherwise have been previously recorded by the owner I1.

Next, in a step 4300, the owner I1 obtains or recomputes its own identification value ID (U1, f1), then recomputes the decryption key sk for the file f1. If the authorization function Aut is a simple sum, the decryption key sk can be obtained simply:

sk=ID(U1,f1)+ACL(U1,f1)

In a step 4400, the owner I1 computes the appropriate value of the new access entry ACL (U2, f1) to be generated for the delegator I2, here according to the following formula:

ACL(U2,f1)=sk−ID(U2,f1)

In a step 4500, this access entry ACL (U2, f1) is incorporated into the public access list ACL of the access management database DB. The access list ACL is public; it is not necessary to encrypt the access list ACL (U2, f1), since this entry taken in isolation would not be enough for a third-party attacker to compute the decryption key sk.

Once the access list ACL (U2, f1) has been incorporated into the public access list ACL, the delegator I2 holds high-level access rights for the file f1. The latter does not need to communicate with the owner I1 to subsequently decrypt the file f1.

Finally, in an optional step 4600, the owner I1 can confirm to the delegator I2 that valid access rights have been incorporated into the public list ACL for the delegator I2. By way of example, an “OK” message can be transmitted to the delegator I2. Alternatively, the delegator I2 can itself perform a verification of the list ACL.

Note that the delegator device I2 could obtain access rights to the file f1 from another delegator I2′, I2″ . . . knowing the value of the decryption key sk, rather than from the owner 11. Specifically, these delegators I2′, I2″ . . . know the value of the decryption key sk, and would therefore be able to generate a valid access entry ACL (U2, f1) after receiving the value ID (U2, d1) from the delegator I2.

If revocations of rights must be implemented, a simple means for the owner I1 to revoke the access rights granted to the different delegators or delegates would consist in generating a new decryption key, and in rendering the previous decryption key obsolete. The rights (access entries, delegations) obtained from the preceding decryption key are then also rendered obsolete. Specifically, as soon as the decryption key is modified, the information of the access list ACL before modification of the key becomes pointless for the devices of the system.

### *Access to an Encrypted File Using Permanent Access Rights (Example 1)

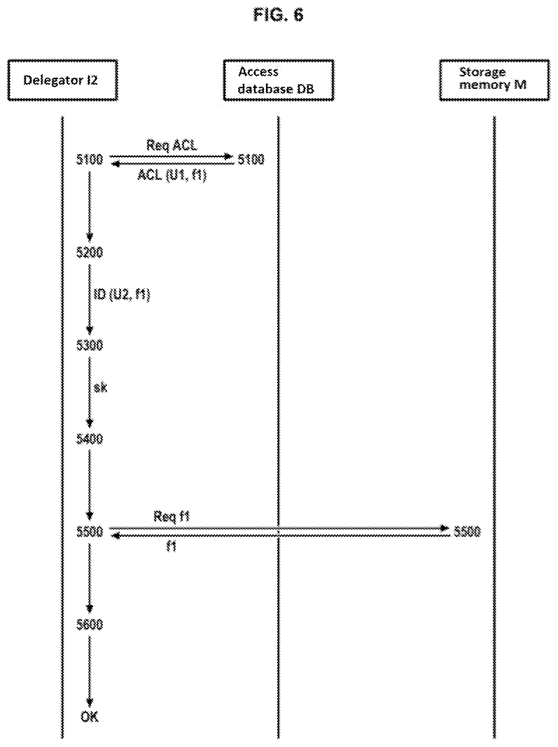

FIG. 6 illustrates the steps of a method for exchanging data between a delegator device (for example I2 or I2′ or I2″), an access management database DB and a file storage memory M, according to an example. The method can be implemented by a processing unit of the delegator device I2. The delegator I2 uses access rights (preferably permanent) which have been previously assigned to it for the encrypted file f1, for example after the method described above and illustrated in FIG. 5.

The access to the contents of the file by the delegator I2 relies on the same general principles as the method of access to the file by the delegate I3 described above, in relation to FIG. 3. To be able to access the contents of the encrypted file f1, the delegate I3 must obtain the value of the decryption key sk which locks the contents of the file f1.

However, a major distinction is that the delegator I2 does not need to receive a delegation from any organization of the network, before accessing the contents of the encrypted file f1. This is because an access has already been assigned to it by the owner 11.

First, in a step S100, the delegator I2 retrieves its access entry ACL (U2, f1) from the public access list ACL. The delegator I2 for example presents its identity using the identifier d(I2), and sends an access request Req ACL. The delegator I2 in return retrieves the ACL access entry (U2, f1).

Then in a step S200, the delegator I2 obtains its own identification value ID(U2, f1) associated with the file f1. The delegator I2 can compute this identification value where applicable, if it does not have it in the memory.

In a step S300, the delegator I2 then computes the decryption key sk for the file f1, as a function of the following two data:
the identification value ID(U2, f1) obtained after step S200;
the access entry ACL(U2, f1) read in step S100 in the access management database DB.

It is recalled that the decryption key sk is here constructed as follows:

sk=Aut(ID(U2,f1),ACL(U2,f1),0)

In the simple example of an authorization function Aut equal to the sum function, the delegator I2 obtains the decryption key sk very simply as a sum of the two abovementioned data. The decryption key sk can optionally be kept in the memory (highly securely) in a step S400 for a subsequent decryption of the file.

The confidentiality of the decryption key sk is preserved, since only the delegator I2 knows its private key U2 allowing it to compute its own identification value ID(U2, f1) associated with the file f1.

In a step S500, the delegator I2 obtains the encrypted file f1 from a memory in which this file is stored, here from the storage memory M. For this purpose, the delegate I3 may transmit a file request Req f1.

Finally, in a step S600, the delegator I2 presents the value of the decryption key sk to access the contents of the file, preferably by symmetric decryption.

If one or more computation servers (delegates I3, I3′ . . . ) have worked on the contents of the file f1, the delegator I2 can then access the modified content.

The set of steps described above, for an access to the file f1 by a delegator I2, are identically transposed for an access by the owner I1 of the file. Here the owner I1 holds the same access rights as the delegator I2, and in particular holds its own access entry ACL (U1, f1) for the file f1.

### *Example 2—Management of Access Rights with Reinforced Anonymity of the Access Entries

According to an alternative protocol (Example 2) for managing access rights to encrypted files, a first identification function ID1 is used for the generation of the identification values and of the delegation values, and a second separate identification function ID2 is used for the generation of the access entries incorporated into the access lists ACL. Hereinafter is a description of the processing methods corresponding to such a protocol.

This alternative protocol repeats the principles described above in relation to a method for delegating of access rights to an encrypted file f1 by a delegator I2 (FIG. 2), in relation to a method for accessing of an encrypted file f1 by a delegate I3 using the delegation value (FIG. 3), in relation to a method for encrypting and recording of a new file f1 by an owner I1 (FIG. 4), in relation to a method for generating of access rights by an owner I1 (FIG. 5) and in relation to a method for accessing of an encrypted file f1 by a delegator I2 using access rights (FIG. 6). Hereinafter the same reference numbers are kept to refer to the steps of these various methods.

The different methods according to this alternative protocol can be implemented by the system 1 for sharing files as described above, in relation to FIG. 1.

A major distinction of the protocol of Example 2, by comparison with the protocol of Example 1, is the use of two separate identification functions ID1 and ID2. The main differences are detailed hereinafter.

During a delegation of access rights (similar to FIG. 2), in step 1100 the value returned by the delegate I3 to the delegator I2 depends on the value ID1 (U3, f1) obtained with the first identification function ID1 for the file f1 and the delegate I3.

For example, the first identification function ID1 is computed as follows:

ID1(U3,f1)=sha256(concatenation(U3,f1,‘ID1’))

Optionally and advantageously, the value returned by the delegate I3 to the delegator I2 is randomized using a random number k obtained by the delegate I3. Note that the value of the random number k is not known to the delegator I2.

For example, the value returned by the delegate I3 to the delegator I2 is equal to:

ID1(U3,f1)+k

The delegator device I2 thus does not have access to the value ID1 (U3, f1) in isolation, since only the delegate device I3 knows the value of the random number k.

In the step 1200, the computing of the delegation value Del′ by the delegator I2 is modified. The delegation value Del′ is here equal to a pair. The first element of the pair Del′ is equal to the difference between the identification value for the delegator I2 and the value previously returned by the delegate I3: ID1 (U2, f1)−[ID1 (U3, f1)+k].

The second element of the pair Del′ is equal to a value obtained with the second identification function ID2 for the file f1 and the delegator I2: ID2 (U2, f1). Thus, in this Example 2, the delegator I2 transmits a value which subsequently allows the delegate I3 to know which access entry must be required in the list ACL(f1) from the database DB.

For example, the second identification function ID2 is computed as follows:

ID2(U2,f1)=sha256(concatenation(U2,f1,‘ID2’))

The values ‘ID1’ and ‘ID2’ are distinct character strings. In this way, the values supplied by the two identification functions ID1 and ID2 are decorrelated and distinct.

Preferably, the transmission 1300 to the delegate device I3 of the delegation Del′ takes the form of a sending of a signed message over a highly secure channel, in the same way as in the Example 1.

During an access to an encrypted file f1 by a delegate I3 using the delegation (similar to FIG. 3), in the step 2100, the delegate I3 sends an access request Req ACL to the access management database DB. The delegate I3 associates with its access request Req ACL the second element ID2(U2, f1) of the Del′ previously received.

In the step 2200, the delegate I3 obtains in return a numerical value ACL(ID2(U2, f1)) of the access entry specific to the delegator I2 for the file f1.

In this Example 2, the access entry takes the form ACL(ID2(U2, f1)). To obtain an access entry from the database DB, it is necessary to submit a numerical value obtained using the second identification function ID2. The access list ACL remains public.

For the computation of the decryption key sk in the step 2400, the delegate I3 obtains or recomputes the identification value ID1 (U3, f1) which is specific to it for the file d1. Based on this value and on the random number k, the delegate I3 obtains the value ID1 (U2, f1).

It is recalled that the random number k is known to the delegate I3. This number has for example been kept securely in a memory of the delegate device I3. The decryption key sk is obtained as follows by the delegate I3 in the step 2400, on the basis of the values previously received:

sk=Aut(ID1(U2,f1),ACL(ID2(U2,f1)),0)

In a simple case, the authorization function Aut used to compute the key returns a sum of the variables taken as input: sk=ID1(U2, f1)+ACL(ID2(U2, f1)).

The decryption and the access to the file f1 occur as in Example 1.

During the creation and encryption of a new file (similar to FIG. 4), the owner I1 uses the first identification function ID1 to compute the new decryption key sk associated with the file f1, and uses the second identification function ID2 to compute the new access entry that is specific to it.

Thus, in the step 3200, the owner I1 computes not only a random integer corresponding to the value of its future access entry, but also computes the value ID2 (U1, f1). The value inserted into the database DB in the step 3350 is equal to ACL(ID2(U1, f1)).

Finally, in the step 3500, the decryption key sk is computed in the same way as above:

sk=Aut(ID1(U1,f1),ACL(ID2(U1,f1)),0)

It is not desirable for the owner I1 to add a secret random integer to obtain the value of the key.

During the generation of new access rights by an owner I1 for a delegator I2 (similar to FIG. 5), it is preferable for the identification value communicated by the delegator I2 to be randomized using a random number k′. The value of the random number k′ is not known to the owner I1.

Thus, in the step 4100, the delegator I2 communicates to the owner I1 the following value: [ID1(U2, f1)+k′].

Here, the owner I1 thus does not have unencrypted access to the value ID1(U2, f1), unlike Example 1 in which the owner I1 receives the value ID(U2, f1) in the step 4100.

In the step 4400, one difference compared to Example 1 is that the owner I1 does not independently compute the new access entry ACL(ID2(U2, f1)) which must be added to the access list ACL for the delegator I2 and the file f1. The computation of said access entry is done in a distributed manner between the owner I1 and the delegator I2.

In this Example 2, in a first sub-step of the step 4400, the owner I1 transmits to the delegator I2 the following value: sk−[ID1(U2, f1)+k′]Based on this, in a second sub-step of the step 4400, the delegator I2 (which is the only one to know the random number k′) can recompute the value [sk−ID1 (U2, f1)].

It is therefore the delegator I2 which, in the step 4500, communicates to the database DB the value of the access entry ACL(ID2(U2, f1)) that will be associated with it in the list ACL for the file f1:

ACL(ID2(U2,f1))=sk−ID(U2,f1)

Finally, the steps of an access to the encrypted file f1 by the delegator I2 using access rights originating from the database DB (similar to FIG. 6) are similar to Example 1. The delegator I2 must submit its identification value ID1(U2,f1) to the database DB so as to obtain the access entry ACL(ID2(U2, f1)). By constructing the value of the access entry in the preceding step 4500, the delegator I2 is able to compute the decryption key sk without being connected to the network simultaneously with the owner I1.

By comparison with the Example 1, a first advantage of the protocol according to Example 2 is that the access entries are anonymized. Based on the numerical value of a public access entry, for example ACL(ID2(U2,f1)), present in the access list ACL(f1), a third party cannot work back to the identity of the device I2. The value of the access entry is obtained from the database DB not by supplying an identifier of the device I2, but by supplying the numerical value ID2(U2,f1) obtained with the second identification function ID2.

A second advantage of the protocol according to Example 2 is that of masking the values of the first identification function ID associated with the different devices, with a randomization of the values of the first identification function ID during the exchanges. Thus, any third-party attacker who might intercept the data communications could not have unencrypted access to the values of the first identification function ID for the delegator I2 or for the delegate I3. The security of the data exchanges is thus reinforced.

1. A method for exchanging data between a delegator device and a delegate device for an access to an encrypted dataset stored in a memory,
an access entry specific to the delegator device and associated with said encrypted dataset being stored in a public access list of an access management database (DB), a decryption key of said encrypted dataset being computable by the delegator device using the access entry, the method comprising the following steps implemented by a processing unit of the delegator device:
receiving an identification value specific to the delegate device and associated with said encrypted dataset,
generating a delegation value as a function of the identification value specific to the delegate device,
such that the delegate device can subsequently receive the delegation value, obtain the access entry specific to the delegator device using the delegation value and compute the decryption key of said encrypted dataset.

2. The method of claim 1, wherein the identification value specific to the delegate device depends on a private key of the delegate device, said identification value being constructed such that a third party cannot obtain said identification value without knowing the private key of the delegate device.

3. The method of claim 1, wherein the identification value specific to the delegate device, denoted ID(U3, f1), is obtained as follows:
ID(U3,f1)=U3+sha256(concatenation(U3,f1))
where f1 is said encrypted dataset,
and where U3 is a private key of the delegate device (I3).

4. The method of claim 1, wherein the delegation value is computed by the processing unit:
as a function of said identification value specific to the delegate device (I3),
and as a function of an identification value specific to the delegator device and associated with said encrypted dataset.

5. The method of claim 4, wherein the identification value specific to the delegator device depends on a private key of the delegator device, said identification value specific to the delegator device being constructed such that a third party cannot obtain said identification value specific to the delegator device without knowing the private key of the delegator device.

6. The method of claim 4, wherein the delegation value is equal to a difference between the identification value specific to the delegator device and associated with said encrypted dataset and the identification value specific to the delegate device and associated with said encrypted dataset.

7. The method of claim 4, wherein the delegation value is equal to a pair,
wherein a first element of said pair depends on a difference between the identification value specific to the delegator device and associated with said encrypted dataset and the identification value specific to the delegate device and associated with said encrypted dataset (f1), and wherein a second element of said pair is equal to an anonymous identification value for the delegate device specific to the delegator device and associated with said encrypted dataset.

8. The method of claim 7, wherein the first element of said pair depends on a random number obtained by the delegate device.

9. The method of claim 1, further comprising the transmission to the delegate device of a signed message containing the delegation value.

10. (canceled)

11. The method of claim 1, wherein a value of the decryption key of said encrypted dataset depends on a function Aut verifying the following equality:
Aut(ID(U2,f1),ACL(U2,f1),0)=Aut(ID(U3,f1),ACL(U2,f1),Del)
where f1 is said encrypted dataset,
where U2 is a private key of said delegator device (I2),
where U3 is a private key of said delegate device (I3),
where Del is said delegation value,
where ID(U2, f1) is said identification value specific to the delegator device (I2) and associated with said encrypted dataset,
where ID(U3, f1) is said identification value specific to the delegate device (I3) and associated with said encrypted dataset,
and where ACL(U2, f1) is said access entry specific to the delegator device (I2) and associated with said encrypted dataset.

12. The method of claim 1, wherein the access entry specific to the delegator device and associated with said encrypted dataset has been previously obtained by an owner server as a function of the decryption key of said encrypted dataset and having been stored in the access management database.

13. The method of claim 12, wherein obtaining the access entry specific to the delegator device and associated with said encrypted dataset comprises sub-steps, implemented by the owner server, of:
obtaining an identification value specific to the delegator device and associated with said encrypted dataset,
receiving, from the access management database, an access entry specific to the owner server and associated with said encrypted dataset,
computing the decryption key,
computing the access entry specific to the delegator device and associated with said encrypted dataset, as a function of said access entry specific to the owner server and as a function of said decryption key.

14. (canceled)

15. A method for exchanging data between a delegate device and an access management database for an access to an encrypted dataset stored in a memory,
an access entry specific to a delegator device and associated with said encrypted dataset being stored in the access management database, said access entry allowing the delegator device to obtain a decryption key of said dataset, the delegate device having previously received a delegation value generated by the delegator device,
the method comprising the following steps implemented by a processing unit of the delegate device (I3):
obtaining the access entry specific to the delegator device and associated with said encrypted dataset,
computing the decryption key of said encrypted dataset, as a function of the following three data:
an identification value specific to the delegate device and associated with said encrypted dataset;
the previously obtained access entry specific to the delegator device and associated with said encrypted dataset;
the delegation value previously received from the delegator device.

16. The method of claim 15, wherein obtaining the access entry specific to the delegator device and associated with said encrypted dataset comprises:
the transmission to the access management database of a datum associated with the delegator device,
the receipt, from the access management database, of said access entry specific to the delegator device (I2) and associated with said encrypted dataset.

17. The method of claim 16, wherein the data transmitted to the access management database (DB) to obtain the access entry specific to the delegator device (I2) and associated with said encrypted dataset comprises an identifier of the delegator device.

18. The method of claim 17, wherein the datum associated with the delegator device which is transmitted to the access management database comprises an anonymized identification value specific to the delegator device and associated with said encrypted dataset.

19. The method of claim 15, further comprising the subsequent steps, implemented by the processing unit of the delegate device, of:
obtaining the encrypted dataset from the memory,
decrypting the encrypted dataset, using the previously computed key.

20. A delegator computer device comprising a processing unit configured to implement a method for exchanging data as claimed in claim 1.

21. A system for sharing encrypted datasets, the set comprising:
an access server comprising an access management database in which is recorded a public access list (ACL) including at least one access entry,
at least one delegator device as claimed in claim 19,
at least one delegate device (I3) comprising a processing unit configured to implement a method for exchanging data with the access management database (DB) as claimed in claim 15.

22-24. (canceled)

25. Storage means readable by a computer on which are recorded code instructions which, when said code instructions are executed by a processing unit, lead said processing unit to implement a method as claimed in claim 1.
